(19) United States
(12) Patent Application Publication
(10) Pub. No.: US 2008/0271031 A1
(43) Pub. Date: Oct. 30, 2008

(54) Resource Partition Management in Kernel Space

(76) Inventor: Dan Herington, Dallas, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/742,533

(22) Filed: Apr. 30, 2007

(51) Int. Cl. G06F 9/50

(52) U.S. Cl. 718/104

(57) ABSTRACT

A method for managing resources in a computing system comprises providing a process initiation function which initiates a process and executing from a kernel an application manager that places the process into a resource partition at process initiation.

### BACKGROUND

Resource partitions use a utility called an application manager to identify processes to be controlled in a partition. The application manager runs in user space and therefore can only move the process to the correct location after the process has begun execution.

Moving a process after execution has begun has limitations. For example, a process that starts in the wrong partition uses resources from the incorrect partition from the time execution begins until the application manager detects that the process has started. Also, if secure resource partitions are implemented, at the instant the process begins executing in the wrong partition security is breached. Thus secure resource partitions have an absolute requirement that the process begins execution in the correct security compartment, eliminating the usefulness of the application manager.

Typically, the application manager is implemented as a user-based daemon that wakes up periodically, for example every 30 seconds, to determine whether any newly started process is in the wrong location and, if so, moving the process to the correction partition.

### SUMMARY

An embodiment of a method for managing resources in a computing system comprises providing a process initiation function which initiates a process and executing from a kernel an application manager that places the process into a resource partition at process initiation.

### BRIEF DESCRIPTION OF THE DRAWINGS

Embodiments of the invention relating to both structure and method of operation may best be understood by referring to the following description and accompanying drawings:

FIGS. 1A and 1B are schematic block diagrams depicting an embodiment of a computing system that is adapted to manage resource partitions in kernel space; and

FIGS. 2A through 2E are multiple flow charts illustrating one or more embodiments or aspects of a method for managing process placement in resource partitions in kernel space.

### DETAILED DESCRIPTION

Illustrative systems and methods enable identification of processes for resource partition controls.

Application process management for resource partitions is moved into the kernel and performed as a process initiation function, for example a system call execo, which starts execution of the process.

In some embodiment, secure resource partition application manager functionality is moved from a user space process to a kernel or operating system process initiation function such as an execo system call.

Resource partitions are a sub-operating system partitioning technology that enables partitioning of resources in a single copy of the operating system. The computing system and associated methods disclosed herein supply functionality for ensuring that as a process is starting on the operating system, the process is placed in the correct secure resource partition.

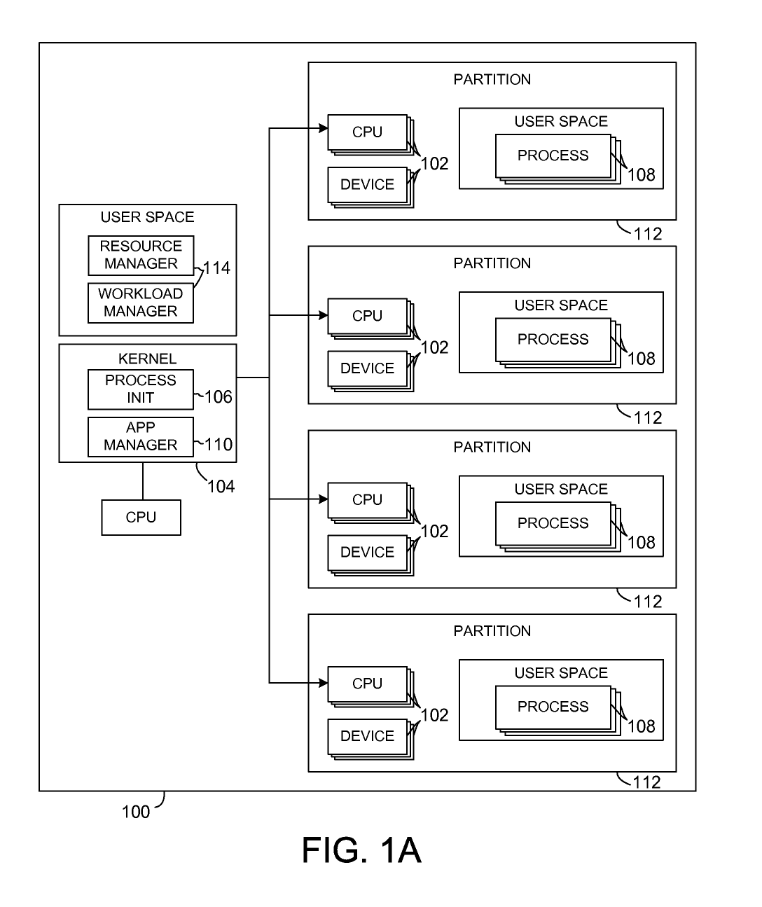

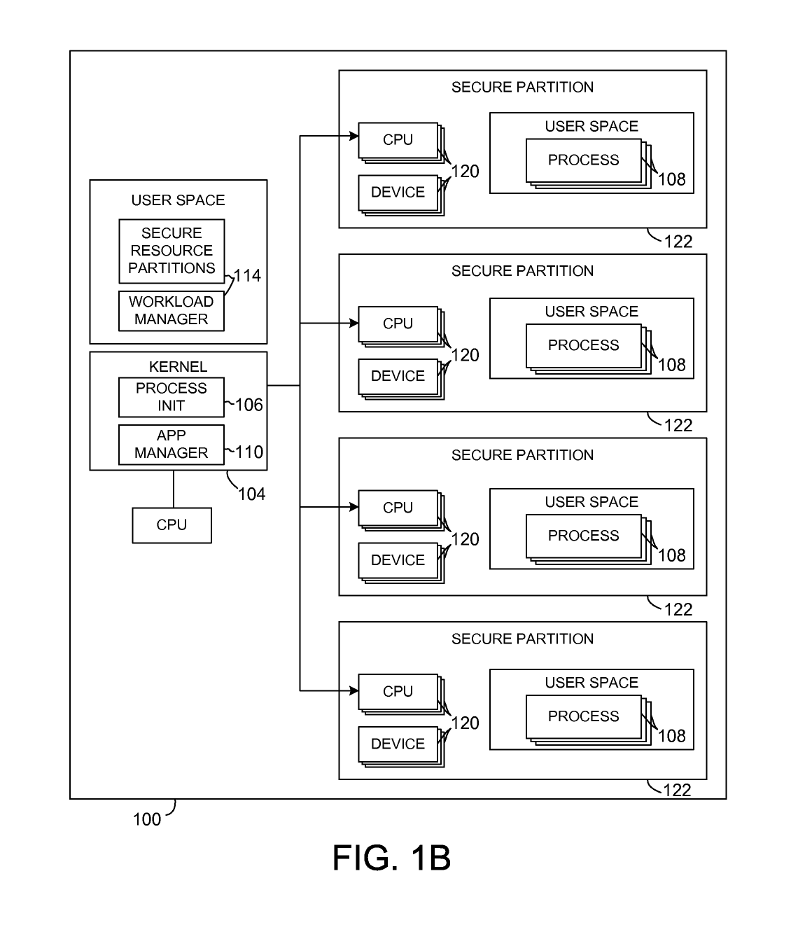

Referring to FIG. 1A, a schematic block diagram depicts an embodiment of a computing system 100 that is adapted to manage resource partitions in kernel space. The illustrative computing system 100 comprises multiple resources 102 and a kernel 104 that operates to manage the resources 102. A process initiation function 106 is used to initiate a process 108. An application manager 110 executes from the kernel 104 and places the process 108 into a resource partition 112 at process initiation.

The application manager 110 identifies processes 108 which are to be controlled in the resource partition or partitions 112. The application manager 110 is a process or executable function that is configured to determine where a process is to execute in a multiple partition system 100, to determine which processes or executables in the system 100 belong in each group or each workload in a resource partition.

Referring to FIG. 1B, a computing system 100 in a secured configuration can further comprise multiple secure resource partitions 122 with multiple secure resources 120 allocated among the secure resource partitions 122. A secure resource partitioning function 114 identifies secure resource partitions 122 that are available to the process 108 at process initiation.

In an example embodiment, the application manager 110 operates to place the process 108 in a secure resource partition 122 at process initiation so that the process 108 only has access to authorized secure resources 120, thereby preventing a security breach. The process initiation function 106 ensures the initiated process 108 always operates from an authorized secure resource partition 122. The initiated process 108 can only consume resources 120 from an authorized secure resource partition 122.

The process initiation function 106, for example an execo system call, determines an appropriate partition 112 for a process 108 to execute even before the process 108 begins by applying a predetermined rule set.

In an illustrative embodiment, the computing system 100 can further comprise a secure resource partitioning function 114 that applies one or more rules for allocating resources in the secure resource partition 122. For example, resources can be allocated according to tagging of an executable file, user identifier (uid) of a user executing a process, group identifier (gid) of a user executing a process, tagging of a process, and many others.

An example of the secure resource partitioning function 114 is a process resource manager (PRM) that enables execution of multiple instances of a program on the system 100 and further enables specific allocation of the amount of each resource to each instance. The application manager 110 executing in the kernel acts in combination with the secure resource partitioning function 114 to ensure that the processes initially begin executing in the correct partitions and allocates how much of each resource a group of processes is allowed to consume. The application manager 110 ensures that processes are activated in the correct place.

Executing application management functionality in the kernel as a process initiation function ensures that processes always begin in the correct secure resource partition. Thus resources are never consumed from an improper secure resource partition and execution never occurs in an inappropriate security compartment, resulting in a security breach.

An example of a process initiation function is a system call execo that executes at the kernel level. Any other type of operating system function that performs similar process initiation can be implemented according to particular system characteristics, target operating system, computer or processor within which the processes are executed, and the like.

Examples of resource partitioning functions 114 can execute as part of applications and utilities such as a workload manager or global workload manager, process resource manager, security compartments, secure resource partitions, or other program. For example, applications, programs, and utilities that can be facilitated by functionality of the process initiation function 106 and the resource partitioning function 114 are those having the ability to start processes in a specific location and manage processes based on groups.

The secure resource partitioning function 114 can determine availability of resources 120 in a secure resource partition 122 to a process 108 before the process 108 is started.

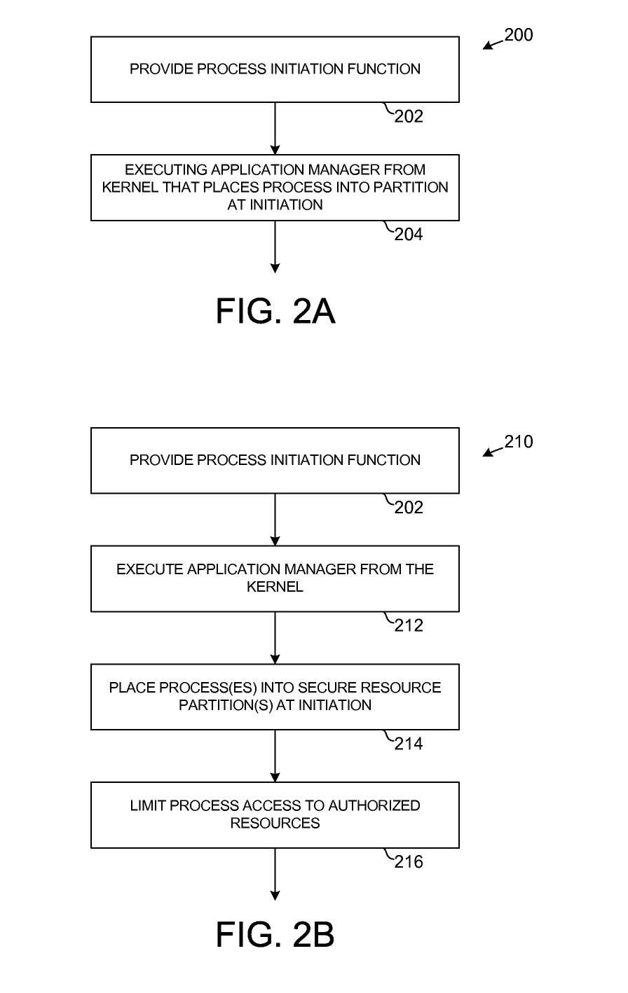

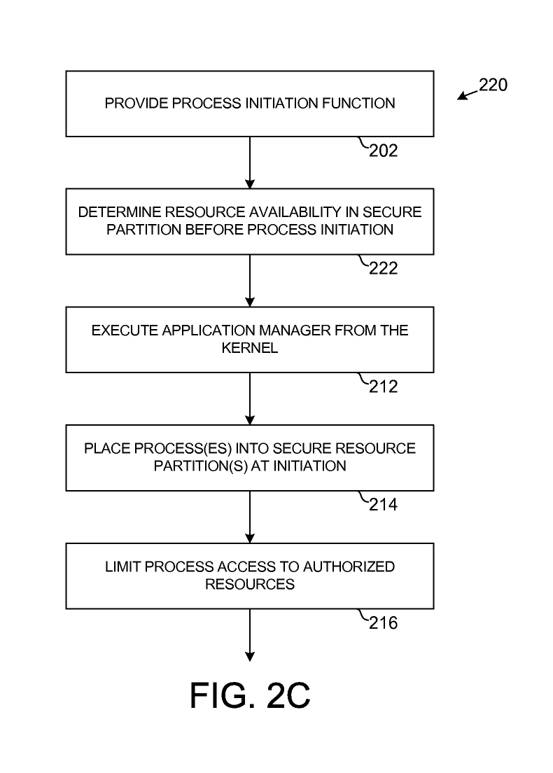

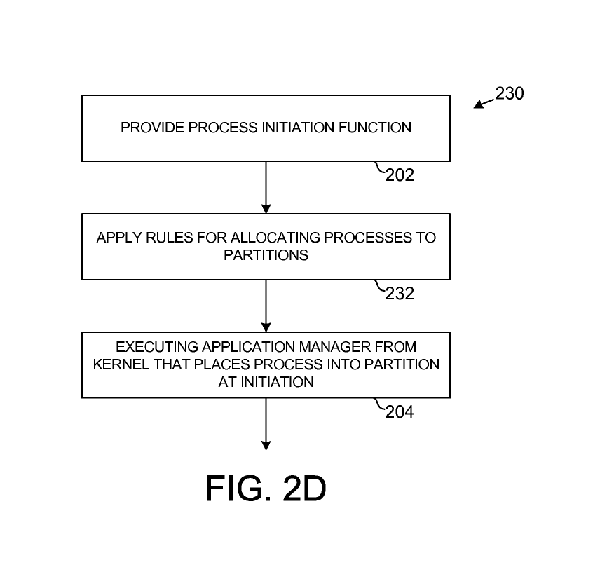

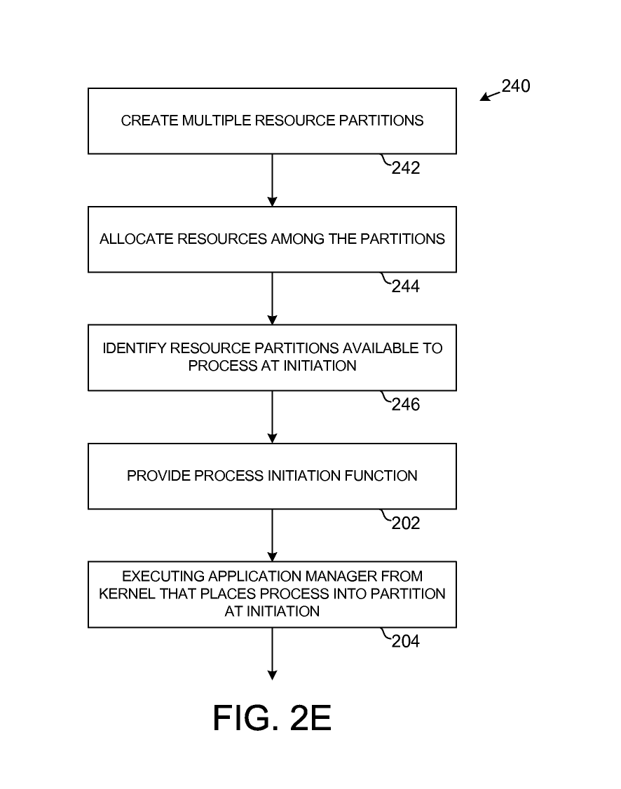

Referring to FIGS. 2A through 2E, multiple flow charts illustrate one or more embodiments or aspects of a method for managing process placement in resource partitions in kernel space. As shown in FIG. 2A, in an example implementation a method 200 for managing resources in a computing system comprises providing 202 a process initiation function which initiates a process and executing 204 from a kernel an application manager that places the process into a designated resource partition at process initiation.

For example, the application manager that is executable from the kernel can identify processes to be controlled in the resource partition or partitions.

As shown in FIG. 2B, in a computing system that includes security controls 210 the application manager executes 212 from the kernel and places 214 the process in a designated secure resource partition at process initiation. The process is thus limited 216 to access to authorized secure resources and security breach is prevented. Thus, the process initiation function executes to ensure the initiated process always operates from an authorized secure resource partition and consumes resources only from an authorized secure resource partition.

The functionality of determining which resource group or security group that the process is to begin executing is performed even before the process begins via operation of the kernel. The rules for determining the appropriate group are typically application-specific and relate to characteristics of the operating system and functions performed. For example, the rules may be different for different operating systems so that Windows, Linux, MAC, Unix, HPUX, and other operating systems can have different rules.

The process name, for example the name of the executable file on a file system, may be used to specify where the process is to execute so that a process starting up has the ability to change the name in a process table. Similarly, the location of a file in the file system can be used to determine an appropriate partition. Also, a tag or other data structure associated with the process can identify the correct partition for execution.

In another example embodiment shown in FIG. 2C, a method 220 can further include determining 222 availability of resources in a secure resource partition to the process before the process is started. Programs for determining resource availability can include portions of workload managers or global workload managers, process resource managers, security compartments, secure resource partitions, or other suitable applications and/or utilities.

Referring to FIG. 2D, another embodiment of a resource management method 230 can apply 232 one or more rules to allocate resources in the resource partition or partitions. Various rules can allocate resources according to tagging of an executable file, allocate resources according to user identifier (uid) of a user executing a process, allocate resources according to group identifier (gid) of a user executing a process, allocate resources according to a tag of a process, and any other suitable allocation technique.

Referring to FIG. 2E, another embodiment of a method 240 for managing resource partitions can comprise creating 242 multiple resource partitions and allocating 244 resources among the resource partitions. One or more resource partitions can be identified 246 that are available to the process at process initiation.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, functionality, values, process variations, sizes, operating speeds, and the like. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A method for managing resources in a computing system comprising:
providing a process initiation function which initiates a process; and
executing from a kernel an application manager that places the process into a resource partition at process initiation.

2. The method according to claim 1 further comprising:
identifying processes to be controlled in the resource partition using the application manager that is executable from the kernel.

3. The method according to claim 1 further comprising:
executing from the kernel the application manager that places the process in a secure resource partition at process initiation whereby the process only has access to authorized secure resources and security breach is prevented.

4. The method according to claim 1 further comprising:
executing the process initiation function whereby the initiated process always operates from an authorized secure resource partition.

5. The method according to claim 1 further comprising:
enabling the initiated process to consume resources only from an authorized secure resource partition.

6. The method according to claim 1 further comprising:
applying at least one rule that allocates resources in the resource partition.

7. The method according to claim 6 further comprising:
the at least one rule selected from a group of rules consisting of allocating resources according to tagging of an executable file, allocating resources according to user identifier (uid) of a user executing a process, allocating resources according to group identifier (gid) of a user executing a process, and allocating resources according to a tag of a process.

8. The method according to claim 1 further comprising:
determining availability of resources in a secure resource partition to a process before the process is started.

9. The method according to claim 1 further comprising:
creating a plurality of resource partitions;
allocating a plurality of resources among the plurality of resource partitions; and
identifying at least one resource partition that is available to the process at process initiation.

10. A computing system comprising:
a plurality of resources;
a kernel operative to manage the resource plurality;
a process initiation function operative to initiate a process; and
an application manager that executes from the kernel and places the process into a resource partition at process initiation.

11. The computing system according to claim 10 further comprising:
the application manager operative to identify processes to be controlled in the resource partition.

12. The computing system according to claim 10 further comprising:
the application manager operative to place the process in a secure resource partition at process initiation whereby the process only has access to authorized secure resources and security breach is prevented.

13. The computing system according to claim 10 further comprising:
the process initiation function operative whereby the initiated process always operates from an authorized secure resource partition.

14. The computing system according to claim 10 further comprising:
the initiated process enabled to consume resources only from an authorized secure resource partition.

15. The computing system according to claim 10 further comprising:
a secure resource partitioning function operative to apply at least one rule that allocates resources in the resource partition.

16. The computing system according to claim 15 wherein:
the at least one rule is selected from a group of rules consisting of allocating resources according to tagging of an executable file, allocating resources according to user identifier (uid) of a user executing a process, allocating resources according to group identifier (gid) of a user executing a process, and allocating resources according to a tag of a process.

17. The computing system according to claim 10 further comprising:
a secure resource partitioning function operative to determine availability of resources in a secure resource partition to a process before the process is started.

18. The computing system according to claim 10 further comprising:
a plurality of secure resource partitions;
the plurality of resources allocated among the plurality of secure resource partitions; and
a secure resource partitioning function operative to identify at least one secure resource partition that is available to the process at process initiation.

19. An article of manufacture comprising:
a controller usable medium having a computable readable program code embodied therein for managing resources in a computing system, the computable readable program code further comprising:
a code adapted to cause the controller to provide a process initiation function which initiates a process; and
a code adapted to cause the controller to execute from a kernel an application manager that places the process into a resource partition at process initiation.
